(19) United States
(12) Patent Application Publication
(10) Pub. No.: US 2012/0182199 A1
(43) Pub. Date: Jul. 19, 2012

(54) MULTI-ANTENNA LOOP LAYOUT

(75) Inventors: YUN-HSIANG YEH, Miaoli (TW); PO-CHIEH CHUANG, Tainan (TW); CHENG-LIANG HSIEH, Hsin-Chu (TW)

(73) Assignee: WALTOP INTERNATIONAL CORPORATION, HSIN-CHU CITY (TW)

(21) Appl. No.: 13/188,697

(22) Filed: Jul. 22, 2011

(30) Foreign Application Priority Data
Jan. 14, 2011 (TW) 100101360

(51) Int. Cl. H01Q 21/08

(52) U.S. Cl. 343/867

(57) ABSTRACT

A multi-antenna loop layout which comprises an array of physical antenna loops, each antenna loop comprising first and second conductive ends. Each conductive end of each antenna loop in the array is coupled to an electrically common contact point that is electrically in common with one or more conductive ends of a subset of other antenna loops in the array. The cumulative total of electrically common contact points, each common contact point being shared by two or more conductive ends of two or more antenna loops in the array, equals a first value T, the first value T being equal to the sum of a second plural value M and a third plural value N. The number of physical antenna loops is equal to at least the product of M and N, and may be as great as T*(T−1)/2.

### BACKGROUND OF THE INVENTION

1. Field of the Invention

The present invention generally relates to a multi-antenna loop layout, and more particularly to a multi-antenna loop layout of an electromagnetic sensitive device.

2. Description of Related Art

Conventional electromagnetic sensitive inputting devices usually include an electromagnetic pointer and a digitizer tablet. The electromagnetic pointer has an oscillation circuit, the inductance value of which may be changed when the electromagnetic pointer approaches the digitizer tablet. The digitizer tablet calculates the position or the pressure of each electromagnetic pointer according to the electromagnetic signal.

The center writing region of a conventional digitizer tablet is composed of an array of U-shaped inductive antenna loops arranged crosswise and distributed respectively along the X and Y axes. FIG. 1 illustrates the layout of antenna loops in the X-direction of a two-dimensional orthogonal coordinate touchscreen system. As shown in FIG. 1, the antenna loop layout 1 includes a plurality of physical antenna loops 101-108. Each of them includes two ends, one end coupled to a single common contact point (com), and the other end comprising a dedicated signal-in end T1-T8. The signal-in ends T1-T8 are coupled with switches SW1-SW8, respectively. Accordingly, the signal inducted by the physical antenna loops 101-108 can be obtained by switching the switches SW1-SW8 in sequence.

However, the number of switches needed in the traditional physical antenna loops increases linearly with the number of the physical antenna loops. As shown in FIG. 1, it needs eight switches SW1-SW8 and nine ends (common contact point (com) and signal-in ends T1-T8) to form eight physical antenna loops 101-108. The bigger the tablet area, the greater the number of physical antenna loops needed. This requires the arrangement of more antenna switches and ends, which increases the corresponding hardware cost and complexity.

In view of the foregoing, a need has arisen for a multi-antenna loop layout that overcomes the above drawback.

### SUMMARY OF THE INVENTION

In view of the foregoing, it is an object of the embodiment of the present invention to provide a multi-antenna loop layout to decrease the number of switches needed and reduce hardware cost and space effectively.

According to one embodiment, a multi-antenna loop layout is provided comprising an array of physical antenna loops, each antenna loop comprising first and second conductive ends. Each conductive end of each antenna loop in the array is coupled to an electrically common contact point that is electrically in common with one or more conductive ends of a subset of other antenna loops in the array. The cumulative total of electrically common contact points, each common contact point being shared by two or more conductive ends of two or more antenna loops in the array, equals a first value T, the first value T being equal to the sum of a second plural value M and a third plural value N. The number of physical antenna loops is equal to at least the product of M and N, and may be as great as T*(T−1)/2.

### BRIEF DESCRIPTION OF THE DRAWINGS

FIG. 1 shows a schematic diagram illustrating a traditional multi-antenna loop layout;

FIG. 2A shows a schematic diagram illustrating a multi-antenna loop layout according to one embodiment of the present invention;

FIG. 2B shows a diagram illustrating a switch group according to one embodiment of the present invention;

FIG. 3A shows a schematic diagram illustrating a multi-antenna loop layout according to another embodiment of the present invention; and

FIG. 3B shows a diagram illustrating a switch group according to another embodiment of the present invention.

### DETAILED DESCRIPTION OF THE INVENTION

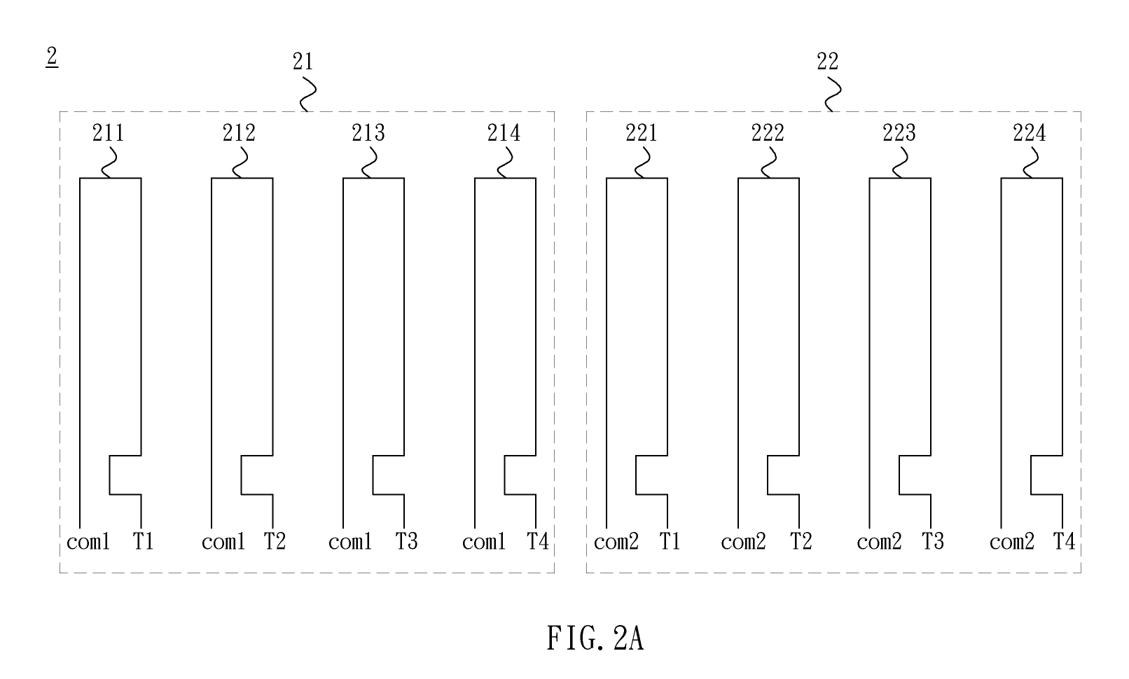

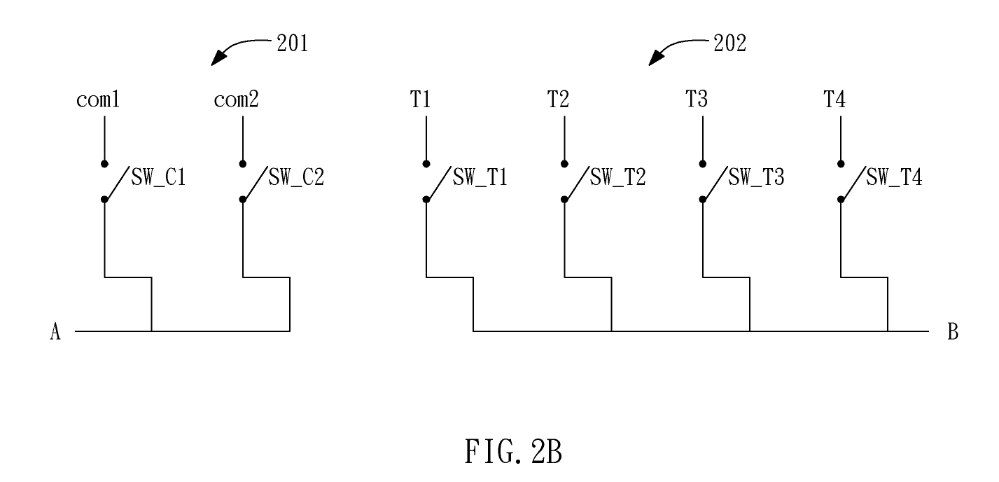

According to one embodiment, an antenna loop layout is provided. FIG. 2A illustrates the layout of antenna loops in the X-direction in a two-dimension orthogonal coordinate input-sensitive system. As shown in FIG. 2A, the antenna loop layout 2 includes two physical antenna loop groups 21, 22 which include four physical antenna loops 211-214 and 221-224, respectively. Each physical antenna loop 211-214 of the physical antenna loop group 21 includes two electrically conductive ends, one of which is coupled to a common contact point com 1 and the other of which comprises a signal-in end T1-T4. Likewise, each physical antenna loop 221-224 of the physical antenna loop group includes two electrically conductive ends, one of which is coupled to a common contact point com2 and the other of which comprises signal-in end T1-T4. In this manner, the two physical antenna loop groups 21, 22 use a common set of signal-in ends T1-T4, and the inductive signal of the signal-in end T1-T4 may be obtained by switching corresponding switches.

FIG. 2B depicts one embodiment of a schematic diagram illustrating a multi-antenna loop layout 2 that ties in with FIG. 2A. The antenna loop layout 2 further includes a first switch group 201 and a second switch group 202. The common contact points com1, com2 of the physical antenna loops 211-214, 221-224 are coupled to a common signal line A via the first switch group 201. More particularly, the first switch group 201 provides switches SW_C1, SW_C2 for connecting the signal line A to a selected one of common contact points com1 or com2. The signal-in ends T1-T4 of the physical antenna loops 211-214, 221-224 are coupled to the second switch group 202. The second switch group 202 provides switches SW_T1, SW_T2, SW_T3, SW_T4 for connecting the signal line B from the process unit (not shown) to a selected one of the signal-in ends T1-T4.

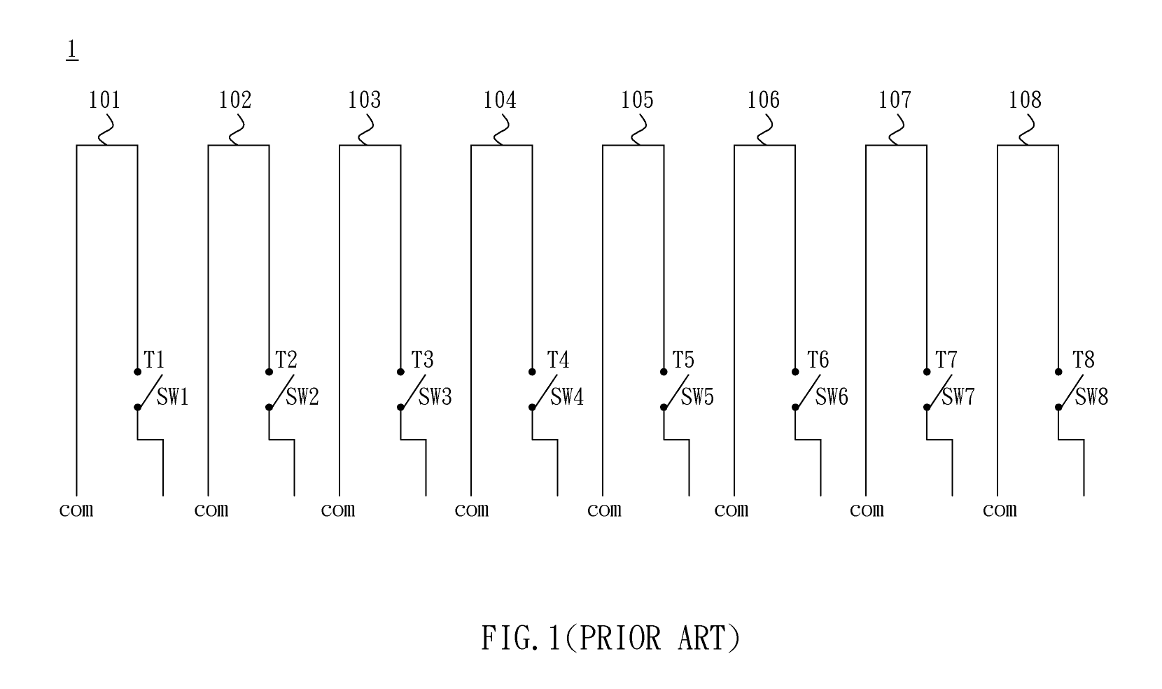

The signal inducted by the physical antenna loops 211-214 may be obtained by controlling the switches SW_C1, SW_C2, SW_T1, SW_T2, SW_T3, SW_T4 of the first switch group 201 and the second switch group 202 in sequence. As illustrated in the above example, a cumulative total of only six electrically common contact points—com1, com2, and signal-in ends T1-T4—are used to enable eight physical antenna loops 211-214, 221-224. More particularly, the two common contact points com1, com2 can be switched by two switches and the four signal-in ends T1-T4 can be switched by four switches to generate the eight physical antenna loops 211-214, 221-224. Moreover, only a total of six switches (as opposed to the eight shown in FIG. 1) are used. A loop layout with N signal-in ends and M opposite-ended common contact points among them can enable M*N discrete and selectable physical antenna loops, using only N number of switches.

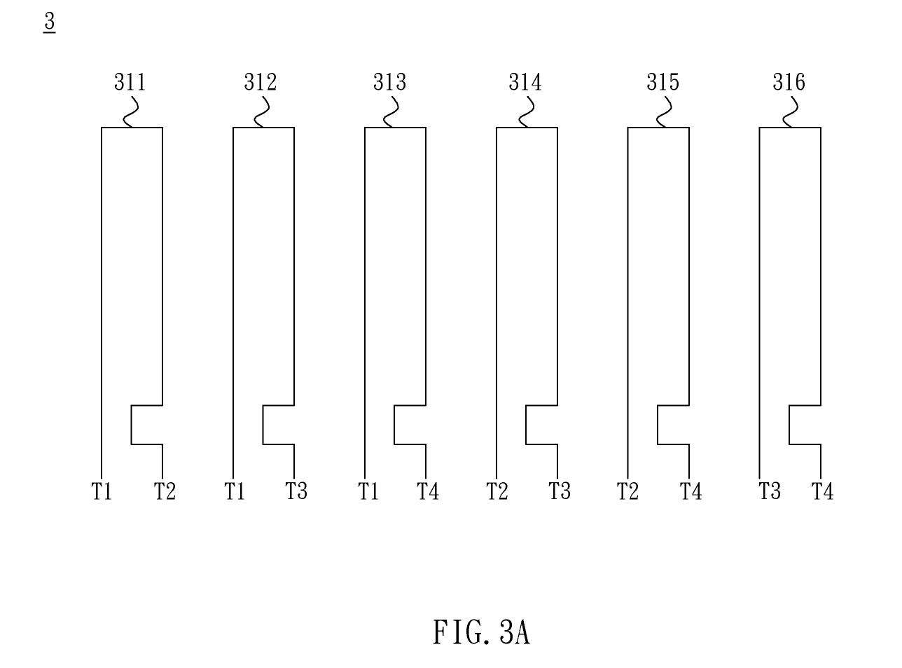

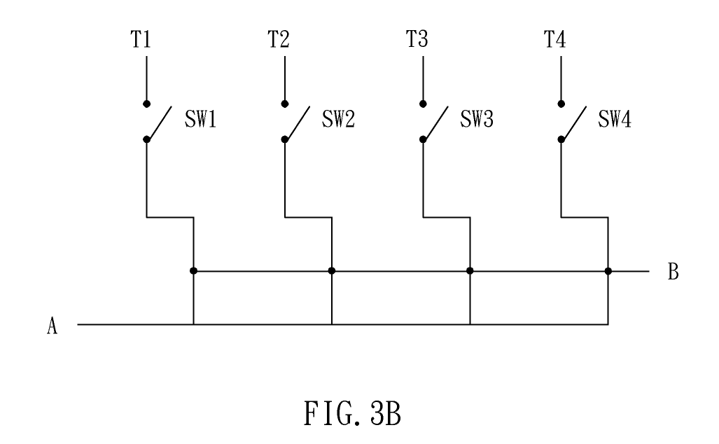

FIG. 3A depicts a schematic diagram of another embodiment of a multi-antenna loop layout 3. This embodiment is similar to the embodiment of FIG. 2A. As shown in FIG. 3A, the antenna loop layout 3 includes six physical antenna loops 311-316. Each of the signal-in ends T1-T4 is coupled to an electrically common contact point. That is, each of the signal-in ends T1-T4 is used in common with some but not all of the antenna loops, and a signal inducted by any one of the six physical antenna loops 311-316 may be obtained by closing switches corresponding to any two selected ones of signal-in ends T1-T4.

FIG. 3B shows a diagram illustrating an embodiment of a switch group that ties in with FIG. 3A. Similar to FIG. 2A, any two of the signal-in ends T1-T4 may be selected by switching corresponding switches to enable a selected physical antenna loop. The first switch group 201 and the second switch group 202 are combined in the present embodiment. Closing a selected one of the switches SW1-SW4 connects the corresponding signal-in end T1-T4 to signal line A, and closing a selected one of the other switches SW1-SW4 connects another corresponding signal-in end T1-T4 to signal line B. Any two selected ones of the signal-in ends forms a single and unique one of the physical antenna loops.

The signal inducted by each of the physical antenna loops 311-316 can be obtained by selectively closing the switches SW1-SW4 in sequence. As illustrated in above example, there are four signal-in ends T1-T4 which constitute common contact points or general signal-in ends. Four switches are used to switch four signal-in ends T1-T4. Due to the fact that each pair of the signal-in ends constitutes the two ends of a unique physical antenna loop, six physical antenna loops 311-316 may be generated, and the number of switches needed is only four. A loop layout with T signal-in ends can generate T*(T−1)/2 physical antenna loops, using only T number of switches.

This antenna loop layout of FIG. 3A is, in fact, capable of enabling more physical antenna loops than the embodiment of FIG. 2A. The total of T signal-in ends T1-T4 of FIG. 3A can be characterized as two separate groups of common contact points, the first having M (e.g., 2) common contact points and the second having N (e.g., 2) common contact points. It can be shown that T*(T−1)/2>M*N, where T=M+N and for all values of M and N greater than or equal to two.

According to the above embodiment, the antenna loop layout, provided in the present invention, controls the two ends of each physical antenna loop so that it is used in common with other ends of other antenna loops, thereby decreasing the total number of switches and ends in a multi-antenna loop layout. This can reduce hardware cost and space effectively.

Although specific embodiments have been illustrated and described, it will be appreciated by those skilled in the art that various modifications may be made without departing from the scope of the present invention, which is intended to be limited solely by the appended claims.

What is claimed is:

1. A multi-antenna loop layout, comprising:
an array of physical antenna loops, each antenna loop comprising first and second conductive ends;
wherein each conductive end of each antenna loop in the array is coupled to an electrically common contact point that is electrically in common with one or more conductive ends of one or more other antenna loops in the array;
wherein a cumulative total of the electrically common contact points, each common contact point being shared by two or more conductive ends of two or more antenna loops in the array, equals a first value T, the first value T being equal to the sum of a second plural value M and a third plural value N;
wherein the array of physical antenna loops provides a number of selectable physical antenna loops equal to at least the product of M and N.

2. The multi-antenna loop layout of claim 1, further comprising:
a first switch group configured to switch M common contact points; and
a second switch group configured to switch the remaining N common contact points;
wherein, the physical antenna loops are generated by closing a selected switch in each of the first and second switch groups.

3. The multi-antenna loop layout of claim 2, wherein the first and second switch groups comprise a total number of the switches equal to the first value T.

4. The multi-antenna loop layout of claim 1, wherein each of the first and second conductive ends is a signal-in end, and wherein each signal-in end is shared with at least one signal-in end of at least one other physical antenna loop and wherein any two selected ones of the signal-in ends forms a single and unique one of the physical antenna loops.

5. The multi-antenna loop layout of claim 4, further comprising:
a group of switches, a first selected one of which is used to electrically connect a selected signal-in end to a first signal line, and a second selected one of which is used to electrically connect another selected signal-in end to a second signal line;
wherein, a selected physical antenna loop is enabled by switching the signal-in ends via the first and second switches, and wherein the number of distinct selectable physical antenna loops in the array equals T*(T−1)/2.

6. The multi-antenna loop layout of claim 5, wherein the group of switches comprises a total number of switches equal to T.
